(19) United States
(12) Patent Application Publication
(10) Pub. No.: US 2023/0098654 A1
(43) Pub. Date: Mar. 30, 2023

(54) WATER PIPE SCALE REMOVAL DEVICE

(71) Applicant: George Bonecutter, St. Charles, MO (US)

(72) Inventor: George Bonecutter, St. Charles, MO (US)

(21) Appl. No.: 17/485,479

(22) Filed: Sep. 26, 2021

(51) Int. Cl. F28G 3/10

(52) U.S. Cl. CPC F28G 3/10

(57) ABSTRACT

An illustrated view of an exemplary water pipe scale removal device is presented. The water pipe scale removal device includes a cutting head configured to be inserted into a pipe. In addition, the water pipe scale removal device includes a flexible drive cable in rotational communication with the cutting head. The cutting head includes a cylindrical shaft having three separated cutting members. Each separated cutting member includes eight elongated cutting blades arranged concentrically around the cylindrical shaft, while each cutting blade has a side cutting edge and a front cutting edge. The cutting blades are oriented at an acute angle to the central axis of the cylindrical shaft. The device is useful for removing scale buildup from a pipe.

The following includes information that may be useful in understanding the present disclosure. It is not an admission that any of the information provided herein is prior art nor material to the presently described or claimed inventions, nor that any publication or document that is specifically or implicitly referenced is prior art.

### FIELD OF THE INVENTION

The present invention relates generally to the field of cleaning devices and more specifically to a water pipe scale removal device.

### BACKGROUND

There are many problems that exist for home and building owners over time. Some issues (such as replacing HVAC vent filters) require routine maintenance and demand simple solutions. Other issues however evolve slowly and may require much more detailed solutions. An example of this is the continuous buildup of minerals and rust which may reduce water flow and damage water systems over, often resulting in significant expenses to the owner.

One way of treating such buildup is the process of pipe descaling. This process may involve the removal of accumulated materials (such as calcium carbonate and magnesium) through the use of specialized tools. These tools may be cost prohibitive for the common homeowner and also may involve specialized training before use. In addition, tools already in practice may not do a good job and would therefore leave some water pipes with a mineral lining still in place. A suitable solution is desired.

### BRIEF DESCRIPTION OF THE DRAWINGS

The advantages and features of the present invention will become better understood with reference to the following more detailed description and claims taken in conjunction with the accompanying drawings, in which like elements are identified with like symbols, and in which:

FIG. 1 is a perspective view of the water pipe scale removal device 10, according to the preferred embodiment of the present invention;

FIG. 2 is a perspective view of the water pipe scale removal device 10, shown in a utilized state, according to the preferred embodiment of the present invention;

FIG. 3 is a sectional view of the water pipe scale removal device 10, as seen along a line I-I, as shown in FIG. 2, according to the preferred embodiment of the present invention; and,

FIG. 4 is a sectional view of the water pipe scale removal device 10, as seen along a line II-II, as shown in FIG. 2, according to the preferred embodiment of the present invention.

### DESCRIPTIVE KEY

10 water pipe scale removal device

15 cutting head

20 flexible drive cable

25 wide diameter section

30 narrow diameter section

35 side cutting edge

40 forward cutting edge

45 potable water pipe

50 rotating power unit

55 concealed space

60 forward face

65 internal diameter “i”

70 gap

75 internal sidewall surface

80 forward travel path “a”

85 rotating travel path “r”

90 mineral deposits

### DESCRIPTION OF THE PREFERRED EMBODIMENTS

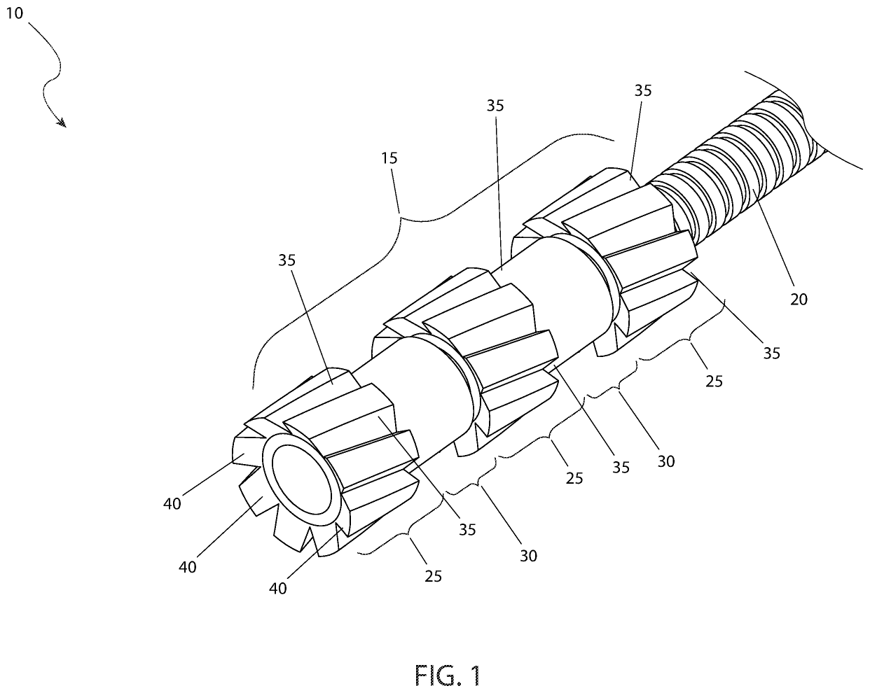

The best mode for carrying out the invention is presented in terms of its preferred embodiment, herein depicted within FIGS. 1 through 4. However, the invention is not limited to the described embodiment, and a person skilled in the art will appreciate that many other embodiments of the invention are possible without deviating from the basic concept of the invention and that any such work around will also fall under scope of this invention. It is envisioned that other styles and configurations of the present invention can be easily incorporated into the teachings of the present invention, and only one (1) particular configuration shall be shown and described for purposes of clarity and disclosure and not by way of limitation of scope. All of the implementations described below are exemplary implementations provided to enable persons skilled in the art to make or use the embodiments of the disclosure and are not intended to limit the scope of the disclosure, which is defined by the claims.

The terms “a” and “an” herein do not denote a limitation of quantity, but rather denote the presence of at least one (1) of the referenced items.

### DETAILED DESCRIPTION OF THE FIGURES

In general, the present invention discloses a pipe scale removal device having a cutting head configured to be inserted into a pipe having an inside diameter. In addition, the device may include a flexible drive cable in rotational communication with the cutting head. The flexible drive cable may be provided in different lengths for varying applications. The cutting head may include a cylindrical shaft with a plurality of separating cutting members, each of which may have an outside diameter that is constructed to be smaller than the inside diameter of the pipe by an amount sufficient to allow the cutting head to be inserted into the pipe. The separated cutting members may be supplied in different diameters to match different sized pipes in varying applications. Each separated cutting member may also have a plurality of elongated cutting blades arranged concentrically around the cylindrical shaft, with each cutting blade having at least one side cutting edge and at least one front cutting edges. Each of the plurality of elongated cutting blades may be configured from masonry cutting type material such as tungsten carbide, although other materials are hereby contemplated as well.

There may also be a prime mover configured to rotate the flexible drive cable in such a manner that then rotates the cutting head. In one version of the device, there may be three (3) cutting members with eight (8) cutting blades on each cutting member. In addition, the cutting blades may be oriented at an acute angle to the cylindrical shaft's central axis. This acute angle may preferably be between 10-20 degrees, although other angles such as 5, 25, 30, etc. may hereby be contemplated. Each cutting blade may also be configured as an elongated rectangular solid with a top surface having two longitudinal vertices and two lateral vertices, and wherein, the side cutting edge is one of the longitudinal vertices and the front cutting edge is one of the lateral vertices. The cylindrical shaft may include a distal end and a proximal end, and at least one of the cutting members may be mounted flush with the distal end of the cylindrical shaft.

In another embodiment, the present invention may disclose a water pipe scale removal device including a cutting head configured to be inserted into a pipe, the pipe having an inside diameter. In addition, the water pipe scale removal device may include a flexible drive cable in rotational communication with the cutting head. The flexible drive cable may be supplied in different lengths for varying applications. The cutting head may include a cylindrical shaft having three separated cutting members. The separated cutting members may be supplied in different diameters to match different sized pipe applications. Each separated cutting member may include eight elongated cutting blades arranged concentrically around the cylindrical shaft, while each cutting blade may have a side cutting edge and a front cutting edge. The elongated cutting blades may be configured from masonry cutting type material such as tungsten carbide, although other materials are hereby contemplated. The cutting blades may be constructed with outside diameter smaller than the inside diameter of the pipe by an amount sufficient to allow the cutting head to be inserted into the pipe. The cylindrical shaft may have a central axis, a distal end and a proximal end. The cutting blades may be oriented at an acute angle to the central axis of the cylindrical shaft. This acute angle may be between 10-20 degrees, although other angles such as 5, 25, 30, etc. may hereby be contemplated. Further, each cutting blade may be configured as an elongated rectangular solid with a top surface having two longitudinal vertices and two lateral vertices, and wherein, the side cutting edge may be one of the longitudinal vertices and the front cutting edge may be one of the lateral vertices. Further still, one of the cutting members may be mounted flush with the distal end of the cylindrical shaft.

In another embodiment, the present invention may disclose a pipe scale removal apparatus having a set of cutting blades mounted on a cylindrical shaft driven by a flexible rotating cable adapted to be inserted into a pipe having a particular inside diameter. The apparatus may include a cylindrical shaft having a central axis and a distal and proximal end, the proximal end constructed to attach to, and be rotated by the flexible rotating cable. The apparatus may also include a plurality of separated gear-like cutting members mounted on the cylindrical shaft, with each cutting member having a plurality of cutting blades arranged around the cutting member in gear-tooth fashion and with each cutting blade being a rectangular solid with a surface having two longitudinal vertices and two lateral vertices. The cutting blades may be configured from tungsten steel, although other materials are hereby contemplated. In addition, each cutting blade may be offset by an acute angle from the central axis of the cylindrical shaft. Each of the cutting members may have an outside diameter smaller than the inside diameter of the pipe by an amount sufficient to allow the apparatus to be inserted into the pipe. The longitudinal vertices may be longer than the lateral vertices. In addition, at least one of the longitudinal vertices may form an edge cutting blade, while at least one of the lateral vertices may form a front cutting blade. Further, one of the separated gear-like cutting members may be mounted flush with the distal end of the cylindrical shaft. The apparatus may be supplied with different outside diameters to match the inside diameter of different sized pipes.

Referring now to FIG. 1, a perspective view of the water pipe scale removal device 10, according to the preferred embodiment of the present invention is disclosed. The water pipe scale removal device 10 (herein also described as the “device”) 10, mechanically removes mineral deposits 90 from the interior of potable water piping. The device 10 consist of a cutting head 15 and a flexible drive cable 20. The cutting head 15 includes a cylindrical body with three (3) wide diameter sections 25 and two (2) narrow diameter sections 30. The wide diameter sections 25 are provided with multiple side cutting edges 35. Each distal wide diameter section 25 is also provided with multiple forward cutting edges 40. The side cutting edges 35 and the forward cutting edges 40 are envisioned to be of the masonry cutting type such as tungsten carbide. As such, the side cutting edges 35 and forward cutting edges 40 are envisioned to be long life and will not require sharpening over time. The cutting head 15 would be made available in multiple sizes with specific diameters of the wide diameter sections 25 to fit the various inside diameters of various piping. The cutting head 15 is permanently attached to the flexible drive cable 20. The flexible drive cable 20 would be approximately three-eighths of an inch (⅜ in.) in diameter and would be made available in multiple lengths such as fifty feet or one-hundred feet (50-100 ft.). The connection at the distal end of the flexible drive cable 20 will be described in greater detail herein below.

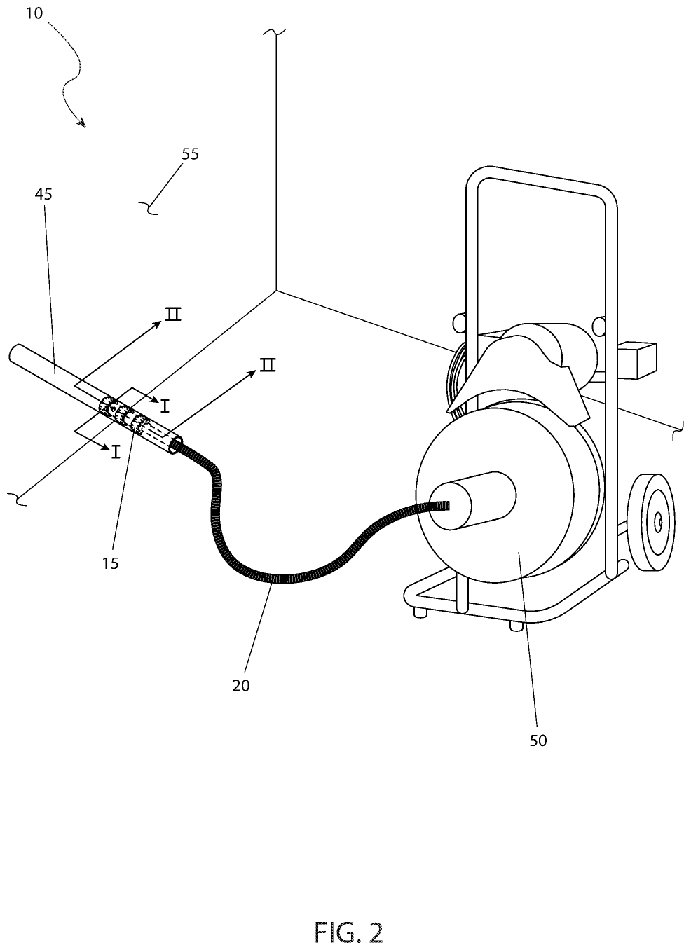

Referring next to FIG. 2, a perspective view of the device 10, shown in a utilized state, according to the preferred embodiment of the present invention is depicted. The cutting head 15 is placed inside of an opened potable water pipe 45. The trailing flexible drive cable 20 is connected to a rotating power unit 50 such as a conventional powered drain auger. However, it is noted that other types of rotating power unit 50 may be used with the device 10. As such, the use of the device 10 with any specific type of rotating power unit 50 is not intended to be a limiting factor of the present invention. The potable water pipe 45 is typically located within a concealed space 55 such as a wall (as shown), pipe chase, embedded in conduit or other locations that make replacement of the potable water pipe 45 a costly endeavor due to labor charges.

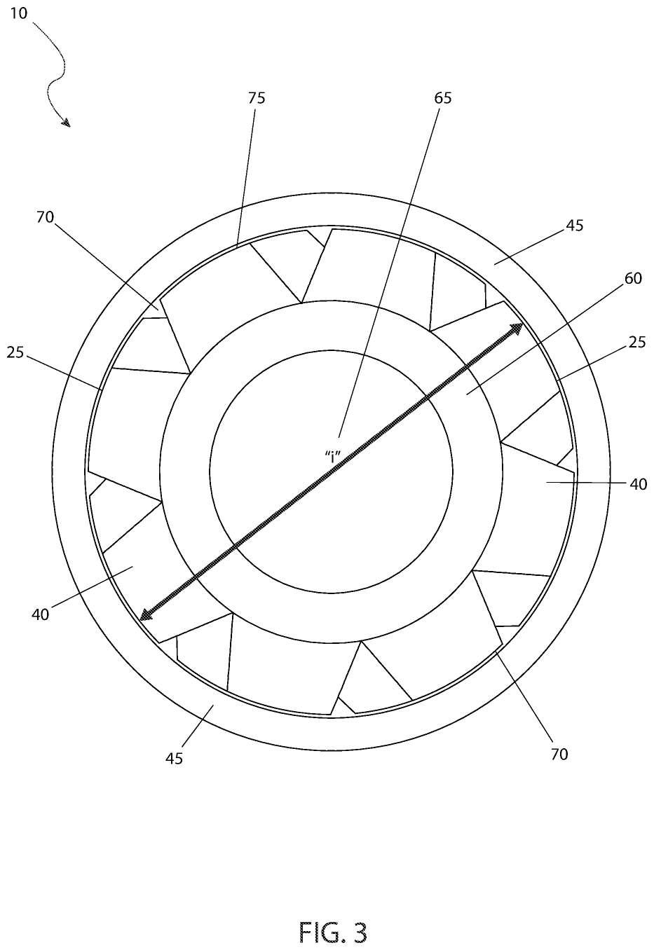

Referring now to FIG. 3, a sectional view of the device 10, as seen along a line I-I, as shown in FIG. 2, according to the preferred embodiment of the present invention is shown. The forward face 60 along with the forward cutting edges 40 are visible and occupy the majority of the internal diameter “i” 65 of the potable water pipe 45. The potable water pipe 45 can be made of any type of metal material such as copper, steel, or the like. It is noted that the wide diameter sections 25 including the forward cutting edges 40 are slightly smaller than the internal diameter “i” 65 to allow for easy forward movement of the cutting head 15 as well as reduced damage to the potable water pipe 45. A gap 70 is thus produced between the forward cutting edges 40 and the internal sidewall surface 75 of the potable water pipe 45.

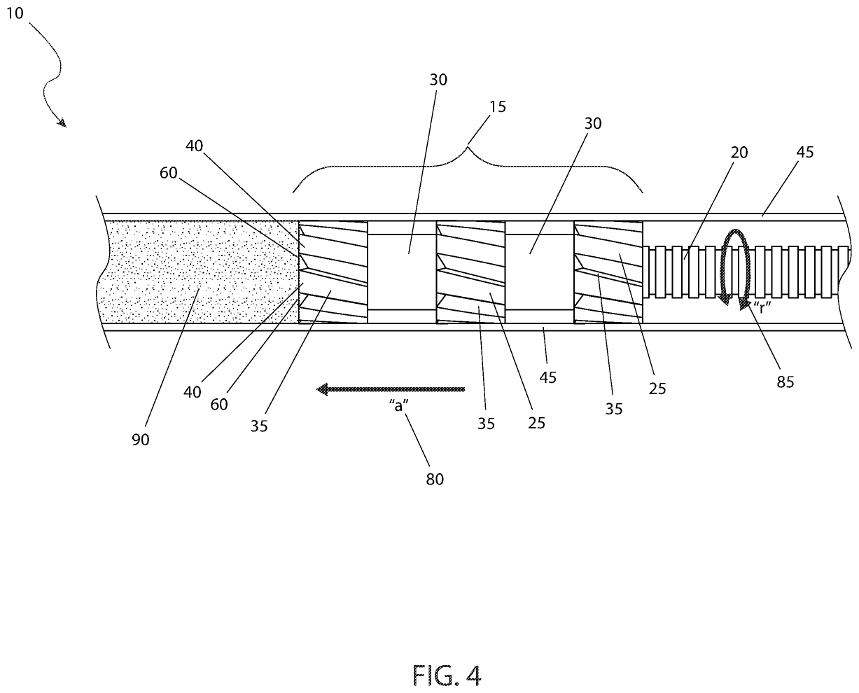

Referring to FIG. 4, a sectional view of the device 10, as seen along a line II-II, as shown in FIG. 2, according to the preferred embodiment of the present invention is disclosed. This view discloses the cutting head 15 as it moves through the potable water pipe 45 along a forward travel path “a” 80 as driven by the flexible drive cable 20 while also moving in a rotating travel path “r” 85. During said movement, the forward cutting edges 40 contact mineral deposits 90 that occur over time in the potable water pipe 45. The forward cutting edges 40 on the forward face 60 as well as the side cutting edges 35 on the wide diameter sections 25 work to dislodge and remove the mineral deposits 90. The narrow diameter sections 30 aid in containment, grinding and further elimination of the mineral deposits 90. It is envisioned that a flush of water or air, opposite the direction of the forward travel path “a” 80 will aid in removal of loosened mineral deposits 90. Once the removal process of the mineral deposits 90 is complete, the cutting head 15 and the flexible drive cable 20 is removed, thus restoring normal pressure and flow operations to the potable water pipe 45 and associated water delivery system.

### Operation of the Preferred Embodiment

The preferred embodiment of the present invention can be utilized by the common user in a simple and effortless manner with little or no training. It is envisioned that the device 10 would be constructed in general accordance with FIG. 1 through FIG. 4. The user would procure the water pipe scale removal device 10 from conventional procurement channels such as plumbing supply houses, hardware stores, home improvement stores, mail order and internet supply houses and the like. Special attention would be paid to the overall diameter of the cutting head 15 and the length of the flexible drive cable 20.

During utilization of the device 10, the following procedure would be initiated: access to the interior of the potable water pipe 45 with mineral deposits 90 will be achieved by removal of a section of the potable water pipe 45 or by a respective fitting; the proper diameter of cutting head 15 with attached flexible drive cable 20 is connected to the rotating power unit 50; the rotating power unit 50 is activated thus feeding the flexible drive cable 20 and the attached cutting head 15 into the potable water pipe 45 via the forward travel path “a” 80 and the rotating travel path “r” 85; cutting action from the forward cutting edges 40 and the side cutting edges 35 removes the mineral deposits 90; a flush of water or air, opposite the direction of the forward travel path “a” 80 will aid in removal of loosened mineral deposits 90. When complete, the cutting head 15 is removed by pulling on the flexible drive cable 20, thus completing the process. After use of the device 10, it is stored until needed again in a cyclical and repeating process.

These features of the device 10 provide the following benefits over conventional mineral deposits 90 removal processes; there are no dangerous chemicals or acids necessary; the device 10 is safe and easy to operate; use of the device 10 does not contaminate the water supply; complete removal of the mineral deposits 90; near instant removal of mineral deposits 90 instead of having to wait twenty-four to forty-eight hours (24-48 h) of use when using chemicals or acid; instant use of the potable water pipe 45 after use; use in tight or cramped locations; use of the device 10 by professional plumbers or do-it-yourselfers alike; and suitability for use in multi-story commercial, industrial and residential buildings.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated.

1. A pipe scale removal device comprising:
a cutting head configured to be inserted into a pipe having an inside diameter;
a flexible drive cable in rotational communication with the cutting head;
the cutting head comprising a cylindrical shaft with a plurality of separated cutting members, each separated cutting member having an outside diameter, and each separated cutting member having a plurality of elongated cutting blades arranged concentrically around the cylindrical shaft, each cutting blade having at least one side cutting edge and at least one front cutting edge;
the outside diameter of the cutting blades constructed to be smaller than the inside diameter of the pipe by an amount sufficient to allow the cutting head to be inserted into the pipe; and
wherein, when a prime mover rotates the flexible drive cable, the cutting head rotates.

2. The pipe scale removal device of claim 1, wherein there are three cutting members.

3. The pipe scale removal device of claim 1, wherein there are eight cutting blades on each cutting member.

4. The pipe scale removal device of claim 1, wherein the cutting blades are oriented at an acute angle to the cylindrical shaft's central axis.

5. The pipe scale removal device of claim 4, wherein the acute angle is between 10-20 degrees with respect to the cylindrical shaft's central axis.

6. The pipe scale removal device of claim 1, wherein each cutting blade is an elongated rectangular solid with a top surface having two longitudinal vertices and two lateral vertices, and wherein, the side cutting edge is one of the longitudinal vertices and the front cutting edge is one of the lateral vertices.

7. The pipe scale removal device of claim 1, wherein the cylindrical shaft has a distal end and a proximal end, and at least one of the cutting members is mounted flush with the distal end of the cylindrical shaft.

8. The pipe scale removal device of claim 1, wherein the separated cutting members are supplied in different diameters to match different sized pipes.

9. The pipe scale removal device of claim 1, wherein the flexible drive cable is supplied in different lengths.

10. The pipe scale removal device of claim 1, wherein the elongated cutting blades are masonry cutting type material such as tungsten carbide.

11. A water pipe scale removal device comprising:
a cutting head configured to be inserted into a pipe having an inside diameter;
a flexible drive cable in rotational communication with the cutting head;
the cutting head comprising a cylindrical shaft having three separated cutting members, the cylindrical shaft having a central axis, a distal end and a proximal end;
each separated cutting member having eight elongated cutting blades arranged concentrically around the cylindrical shaft, each cutting blade having a side cutting edge and a front cutting edge;
the cutting blades constructed with outside diameter smaller than the inside diameter of the pipe by an amount sufficient to allow the cutting head to be inserted into the pipe;
wherein, the cutting blades are oriented at an acute angle to the central axis of the cylindrical shaft;
wherein each cutting blade is an elongated rectangular solid with a top surface having two longitudinal vertices and two lateral vertices, and wherein, the side cutting edge is one of the longitudinal vertices and the front cutting edge is one of the lateral vertices, and
wherein one of the cutting members is mounted flush with the distal end of the cylindrical shaft.

12. The water pipe scale removal device of claim 11, wherein the acute angle is between 10-20 degrees with respect to the cylindrical shaft's central axis.

13. The water pipe scale removal device of claim 11, wherein the separated cutting members are supplied in different diameters to match different sized pipes.

14. The water pipe scale removal device of claim 11, wherein the flexible drive cable is supplied in different lengths.

15. The water pipe scale removal device of claim 11, wherein the elongated cutting blades are masonry cutting type material such as tungsten carbide.

16. A pipe scale removal apparatus having a set of cutting blades mounted on a cylindrical shaft driven by a flexible rotating cable adapted to be inserted into a pipe having a particular inside diameter, the apparatus comprising;
a cylindrical shaft having a central axis and a distal and proximal end, the proximal end constructed to attach to, and be rotated by the flexible rotating cable;
a plurality of separated gear-like cutting members mounted on the cylindrical shaft, the cutting member having a plurality of cutting blades arranged around the cutting member in gear-tooth fashion, each cutting blade being a rectangular solid with a surface having two longitudinal vertices and two lateral vertices, the longitudinal vertices being longer than the lateral vertices, wherein one of the longitudinal vertices forms an edge cutting blade, and one of the lateral vertices forms a front cutting blade; and
wherein, one of the separated gear-like cutting members is mounted flush with the distal end of the cylindrical shaft.

17. The pipe scale removal apparatus of claim 16, wherein each cutting blade is offset by an acute angle from the central axis of the cylindrical shaft.

18. The pipe scale removal apparatus of claim 16, wherein each of the cutting members has an outside diameter smaller than the inside diameter of the pipe by an amount sufficient to allow the apparatus to be inserted into the pipe.

19. The pipe scale removal apparatus of claim 16, wherein the cutting blades are tungsten steel.

20. The pipe scale removal apparatus of claim 18, wherein the apparatus is supplied with different outside diameters to match the inside diameter of different sized pipes.
